(19) United States
(12) Patent Application Publication
(10) Pub. No.: US 2015/0244292 A1
(43) Pub. Date: Aug. 27, 2015

(54) SYSTEM AND METHOD FOR ENERGY MANAGEMENT FOR ELECTRIC DRIVE SYSTEM

(71) Applicant: Caterpillar Inc., Peoria, IL (US)

(72) Inventors: Baojun Si, Dunlap, IL (US); Dustin Selvey, Peoria, IL (US); William J. Tate, Dunlap, IL (US); Alexander C. Crosman, III, Dunlap, IL (US)

(73) Assignee: Caterpillar Inc., Peoria, IL (US)

(21) Appl. No.: 14/711,856

(22) Filed: May 14, 2015

(51) Int. Cl. H02P 3/22

(52) U.S. Cl. CPC H02P 3/22

(57) ABSTRACT

The present disclosure is related to a method for energy management for an electric drive system during regenerative braking of a machine. The machine includes an electric drive assembly. The electric drive assembly includes a generator, a motor, a primary direct current bus and a secondary direct current bus having a regenerative brake assembly. The method of energy management includes connecting at least a chopper and a crowbar across the secondary direct current bus. Further, the method includes directing a secondary power stored during regenerative braking, from the primary or secondary or both the buses through the chopper or the crowbar during fault condition.

### TECHNICAL FIELD

The present disclosure relates to a system and method for energy management of a machine system, and more particularly energy management of an electric drive system.

### BACKGROUND

Machines, such as mining trucks, use retarding grid or resistors to burn off the retarding power when machine is at retarding mode. The retarding grid generates heat to dissipate the retarding power. This method increases the fuel consumption and consequently reduces the fuel efficiency and increases the owning and operating costs.

For machines, such as mining trucks, regenerative braking might be utilized for improving fuel efficiency. Such machines include an electric drive system that is driven by an engine. The electric drive includes a generator coupled to a motor by means of a primary direct current bus, and a regenerative braking unit that is disposed between the generator and the motor through a secondary direct current bus. During, regenerative braking the mechanical energy is converted into electrical energy that is stored within the primary and the secondary direct current bus.

However, while the system might be energized, both primary bus and secondary bus might store significant energy. In emergency conditions, the electrical energy stored within the primary and secondary direct current buses may need to be dissipated, since this energy is not essential for system operation. The system may include a chopper circuit or a crowbar circuit to control voltage between a lower threshold limit and an upper threshold limit Some electric drive system include two chopper or crowbar circuits, such that one chopper or crowbar circuit is provided at the primary direct current bus and another chopper or crowbar circuit is provided at the secondary direct current bus. Such systems hence require use of additional hardware in the system.

U.S. Pat. No. 6,072,291, hereinafter referred as, the '291 patent, describes a frequency convertor for an electromotor. The frequency converter includes an intermediary circuit, in which a braking circuit with a switch and a load is arranged. The frequency converter protects the electromotor, even though the load is placed outside the frequency converter by galvanically separating the load from the intermediary circuit. However, the '291 patent does not provide a solution to dissipate energy during a fault condition of the system using reduced hardware.

### SUMMARY OF THE DISCLOSURE

In one aspect of the present disclosure a system and method of energy management associated with a machine having an electric drive system is provided. The electric drive system includes a motor coupled to a generator via a primary direct current bus. The electric drive system further includes a regenerative braking assembly connected between the motor and the generator via a secondary direct current bus. The method includes connecting at least one of a chopper and a crowbar across the secondary direct current bus. The method includes directing to at least one of the primary current bus and the secondary current bus through at least one of the chopper and the crowbar during a fault condition. Further, the secondary power is stored at least one of the primary bus and the secondary bus, such that the secondary power is not essential for system operation.

Other features and aspects of this disclosure will be apparent from the following description and the accompanying drawings.

### BRIEF DESCRIPTION OF THE DRAWINGS

FIG. 1 is a side view of an exemplary machine having an electric drive system, according to an embodiment of the present disclosure;

FIG. 2 is a circuit diagram of an electric drive assembly, according to an embodiment of the present disclosure; and

FIG. 3 is a flowchart of a method for energy management in the electric drive assembly.

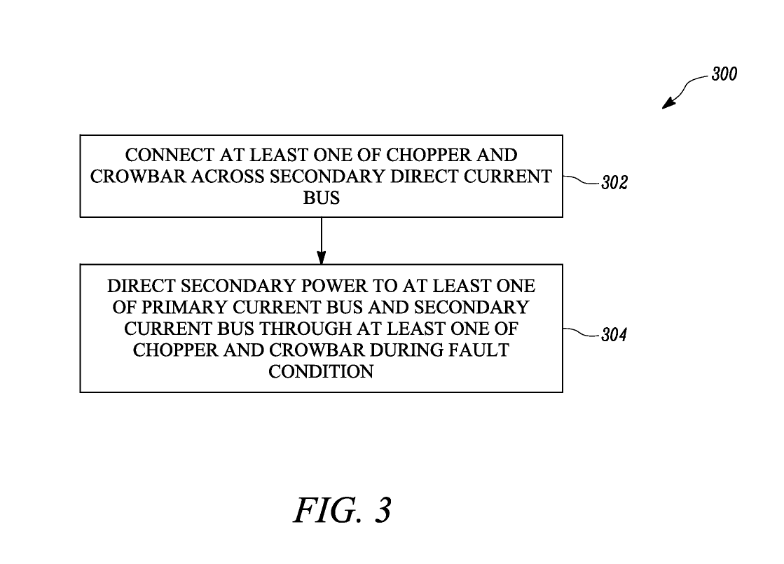

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

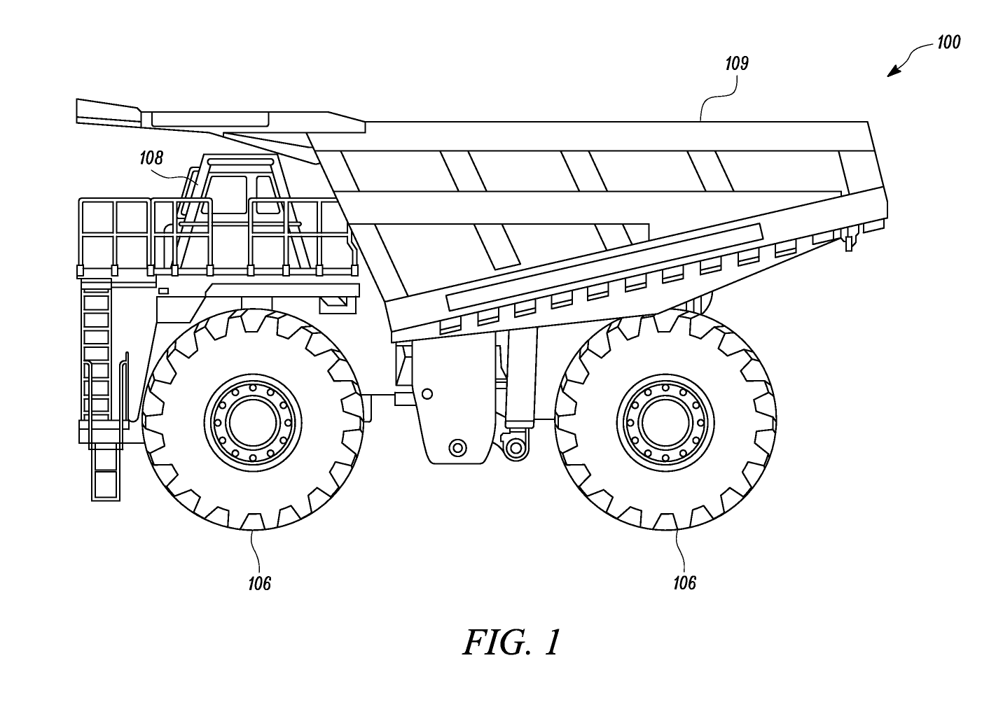

FIG. 1 shows a side view of an exemplary machine 100. The machine 100 is a mining truck. Alternatively, the machine 100 may include any other machine 100, such as, for example, an excavator, a loader, a dozer, or any other machine or engine system including an electric drive system.

Referring to FIG. 1, an exemplary machine 100 is illustrated according to one embodiment of the present disclosure. The machine 100 is a mining truck. Alternatively, the machine 100 may include any other machine 100, such as, for example, an excavator, a loader, a dozer, a track type tractor, or any other machine or engine system including an electric drive system.

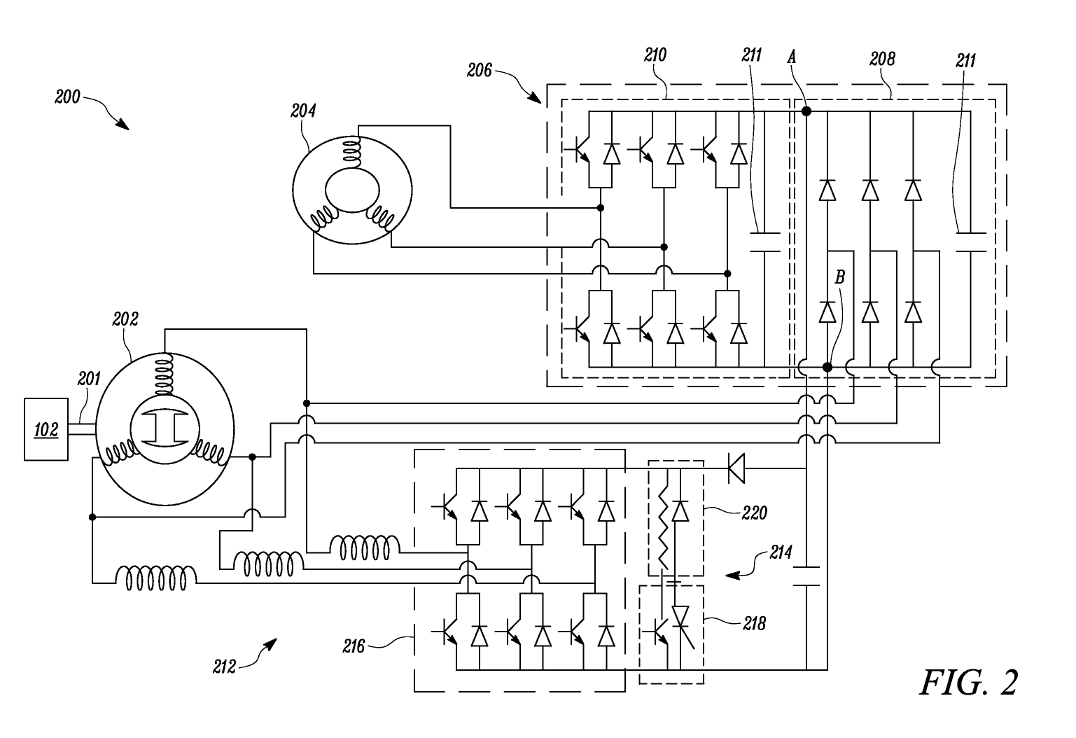

The machine 100 includes an engine 102 (see FIG. 2) and an electric drive assembly 200 (see FIG. 2) connected to wheels 106 of the machine 100. The engine 102 may be an internal combustion engine which runs on diesel, gasoline, gaseous fuels, or a combination thereof. The engine 102 may be of various configurations, such as in-line, V-type etc. Further, the engine 102 may provide power to various components of the machine 100, such as, the electric drive assembly 200. It is contemplated that the electric drive assembly 200 may also be used with other type of power source such as, for example, a fuel cell.

The machine 100 includes an operator cabin 108 disposed above the electric drive assembly 200 and a load body 109, that is a dump body. In an alternate embodiment the load body 109 may be a bucket, ripper and the like. The operator cabin 108 includes an operator seat and multiple control devices (not shown) configured to control the machine 100 for various operations.

The present disclosure relates to energy management associated with the electric drive assembly 200 of the machine 100 and will be described in detail in connection with FIG. 2. Referring to FIG. 2 a circuit diagram of the electric drive assembly 200 is illustrated, according to one embodiment of the present disclosure. The electric drive assembly 200 includes a generator 202 that is drivably coupled to the engine 102 by an output shaft 201.

The generator 202 receives input power from the engine 102 and converts mechanical energy into electrical energy. The generator 202 may be a three-phase permanent magnet alternating field-type generator configured to produce a power output in response to a rotational input from the engine 102. It is also contemplated that the generator 202 may be a switched reluctance generator, a direct phase generator, or any other appropriate type of generator known in the art. The generator 202 may include a rotor (not shown) rotatably connected to the engine 102 by any means known in the art such as, for example, by the shaft, via a gear train, through a hydraulic circuit, or in any other appropriate manner. The generator 202 may be configured to produce electrical power output as the rotor is rotated within a stator (not shown) by the engine 102.

The electric drive assembly 200 includes a motor 204 drivably engaged to the wheels 106. The motor 204 may be connected to the wheels 106 with a direct shaft coupling (not shown), a gear mechanism, or in any other manner known in the art. In an embodiment there may be one or more motors 204, configured to rotate or brake the wheels 106 of the machine 100. The motor 204 may be an alternating current induction motor that converts the electrical energy into mechanical energy. It is also contemplated that the motor 204 may be a switched electric motor, a direct phase motor, permanent magnet alternating field type motor, or any other appropriate type of motor known in the art. In the exemplary embodiment, the motor 212 is a three phase alternating current induction motor configured to receive power from the generator 202 through a primary direct current bus 206.

The primary direct current bus 206 is an electric circuit including multiple electrical components configured to convert alternating current to direct current received in the form of electrical energy from the generator 202. The primary direct current bus 206 includes a rectifier circuit grid 208 and a traction inverter circuit grid 210. An energy storage device 211 such as, for example, a capacitor, or any other type of known supercapacitor, ultracapacitor, or battery is provided across the rectifier circuit grid 208 and the traction inverter circuit grid 210. The rectifier circuit grid 208 converts alternating current from the generator 202 to direct current. The traction inverter circuit grid 210 converts the direct current from the rectifier circuit grid 208 to three phase alternating current and further supplies to the motor 204.

The electric drive assembly 200 includes a regenerative braking assembly 212 connected between the generator 202 and the motor 204 through a secondary direct current bus 214. The regenerative braking assembly 212 is connected to the primary direct current bus 206 through nodes “A” and “B” at an input side of the regenerative braking assembly 212. The generator 202 is connected at output side of the regenerative braking assembly 212. The regenerative braking assembly 212 includes an inverter circuit grid 216. The inverter circuit grid 216 converts the direct current to alternating current. The electric drive assembly 200 may additionally include a controller (not shown) in communication with the motor 204, the generator 202, and the secondary direct current bus 214.

A chopper circuit 218, a crowbar circuit 220, or both are connected in series across the secondary direct current bus 214. In one embodiment, the chopper circuit 218 and crowbar circuit 220 are arranged in such a manner that the chopper circuit 218 is configured to prevent overvoltage and overcurrent across the inverter circuit grid 216 of the secondary direct current bus 214; and the crowbar circuit 220 is configured to prevent overvoltage and overcurrent across the primary direct current bus 206.

The chopper circuit 218 may be of step-up or a step-down type that converts fixed direct current input to a variable direct current output voltage. Further, the chopper circuit 218 may include a control unit and a power circuit (not shown). The control unit is configured to control the switching on and off of the power circuit. The power circuit of the chopper circuit 218 includes an overvoltage protection module (not shown) and a rectifier module (not shown). The overvoltage protection module of the chopper circuit 218 is configured to protect the secondary direct current bus 214 from damages due to overvoltage. The rectifier module is configured to protect the secondary direct current bus 214 from damages due to over-current.

The overvoltage protection module of the chopper circuit 218 is electrically coupled to the secondary direct current bus 214. The over voltage protection module may further include one or more discharge units (not shown) formed by a discharge resistor and a switch element (not shown) coupled in series. The discharge unit is electrically coupled to the control unit via the switch element. The control unit may further by configured to drive the switch element to be on or off according to the detected direct current voltage. The average value of the output voltage is controlled by periodic opening and closing of a switch element (not shown) used in the chopper circuit 218. In an embodiment the switch element may be a fully-controlled power element. The rectifier module and the overvoltage protection module may be coupled in parallel, and the output terminals of the rectifier module may be coupled to the output terminals of the secondary direct current bus 214.

The crowbar circuit 220 connected across the secondary direct current bus 214 is configured to prevent damage due to overcurrent and overvoltage of the primary direct current bus 206 by putting a short circuiting or a low resistance (not shown) path across the nodes “A” and “B”. The short circuiting of the primary direct current bus 206 within the crowbar circuit 220 may be done using a thyristor, or trisil or a thyratron. The short circuit across the nodes “A” and “B” trips the circuit breaker (not shown), thus preventing the damage of the primary direct current bus 206.

The chopper circuit 218 and/or the crowbar circuit 220 is configured to direct a secondary power to the primary direct current bus 206 or the secondary direct current bus 214, allowing for energy stored on the primary direct current bus 206, the secondary direct current bus 214, or both to be dissipated during a fault or emergency condition. This energy is not essential for system operation, and typically includes power captured by the grid, etc.

During regenerative braking, the motor 204 converts the braking mechanical energy into electrical energy. The electrical energy gets stored within the primary and secondary direct current buses 206, 214 and that may vary with varying braking motion. In one situation, the threshold direct current voltage across the primary and secondary direct current buses 206, 214 may be say “V1”. There may be a sudden drop and recovery of the direct current voltage, say “V2” across the nodes “A” and “B”, such that the direct current voltage “V2” is higher than the threshold direct current voltage “V1”. The direct current voltage “V2” is detected by the control unit. The control unit outputs a control signal, so as to drive the switch element to be on, when the control unit detects that the direct current voltage is lowered below threshold voltage “V1”, the control unit 28 outputs another control signal, so as to drive the switch element to be off. In this way the chopper circuit 218 step-downs the over voltage across the nodes “A” and “B”, within the operable threshold limit “V1”.

In an example, when the direct current voltage of the primary direct current bus 206 drops and the generator 202 generates a high rotor inrush current, the chopper circuit 218 absorbs or shunts a portion of the rotor inrush current through the rectifier module. Accordingly, the amount of the rotor inrush current flowing into the primary direct current bus 206 is decreased. Thus, the excess energy or the energy in the form of over-current is dissipated.

During a fault condition, when the direct current voltage is higher than the predetermined threshold voltage “V1”, an output terminal of the controller sends a driving signal to the crowbar circuit 220. The driving signal drives an insulated gate bipolar transistor (not shown) to be on. The excess voltage is absorbed by the crowbar circuit 220. This in turn may lead to a voltage drop across primary direct current bus 206. Similarly, if the current flowing into the inverter circuit grid 216 is detected to be higher than a predetermined threshold current of over-current protection, the output terminal of the controller can send an insulated gate bipolar transistor driving signal to the crowbar circuit 220, so as to drive the insulated gate bipolar transistor to be on, and thus the crowbar circuit 220 absorbs the remaining energy generated by the grid voltage drop.

### INDUSTRIAL APPLICABILITY

The present disclosure relates to a method 300 of managing energy within the electric drive system 200 by effectively dissipating the secondary power of the primary and secondary current buses 206, 214 during the fault condition. At step 302, the chopper circuit 218, the crowbar circuit 220, or both is connected across the secondary direct current bus 214. At step 304, the secondary power of the primary direct current bus 206, the secondary direct current bus 214, or both is directed through the chopper circuit 218, the crowbar circuit 220, or both.

In the present disclosure, the excess energy or the secondary power that is not essential to the system operation that may cause overvoltage or overcurrent during faulty operation is dissipated through the chopper circuit 218 and the crowbar circuit 220. Further, this may prevent short circuiting and overheating of the primary direct current bus 206 and the secondary direct current bus 214. By providing the hardware at only one location in the circuit, that is at the secondary direct current bus 214 the secondary power present at both the primary and secondary direct current buses 206, 214 may be dissipated through the chopper circuit 218, the crowbar circuit 220, or both. Hence, the disclosure provides a cost effective solution that is compact in design and implementation.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of energy management for an electric drive system associated with a machine, wherein the electric drive system includes a motor coupled to a generator via a primary direct current bus, and a regenerative braking assembly connected between the motor and the generator via a secondary direct current bus, the method comprising:
connecting at least one of a chopper and a crowbar across the secondary direct current bus; and
directing a secondary power to at least one of the primary current bus and the secondary current bus through at least one of the chopper and the crowbar during a fault condition, wherein the secondary power is energy stored at least one of the primary bus and the secondary bus, such that the secondary power is not essential for system operation.
